(19) United States
(12) Patent Application Publication
(10) Pub. No.: US 2025/0149711 A1
(43) Pub. Date: May 8, 2025

(54) POWER STORAGE DEVICE

(71) Applicant: TOYOTA JIDOSHA KABUSHIKI KAISHA, Aichi-ken (JP)

(72) Inventors: Eiji YOSHIDA, Seto-shi (JP); Masanori KODERA, Toyota-shi (JP)

(21) Appl. No.: 18/931,048

(22) Filed: Oct. 30, 2024

(30) Foreign Application Priority Data
Nov. 2, 2023 (JP) 2023-188520

(51) Int. Cl. H01M 50/242; H01M 50/209; H01M 50/249; H01M 50/271; H01M 50/291; H01M 50/293

(52) U.S. Cl. CPC H01M 50/242; H01M 50/209; H01M 50/249; H01M 50/271; H01M 50/291; H01M 50/293

(57) ABSTRACT

A power storage device includes a power storage stack including a plurality of power storage cells, a lower case accommodating the power storage stack, an upper cover covering the power storage stack, an outside elastic body made of an elastic material and provided on an outer surface of the upper cover, and an inside elastic body made of an elastic material and provided on an inner surface of the upper cover. The inside elastic body has a spring constant larger than a spring constant of the outside elastic body.

### CROSS REFERENCE TO RELATED APPLICATIONS

This nonprovisional application is based on Japanese Patent Application No. 2023-188520 filed on Nov. 2, 2023 with the Japan Patent Office, the entire contents of which are hereby incorporated by reference. BACKGROUND Field

The present disclosure relates to a power storage device. Description of the Background Art

For example, Japanese Patent Laying-Open No. H10-69893 discloses a pack battery that includes a case accommodating a battery, and a rubber sponge provided on an inner surface of an upper case of the case.

### SUMMARY

When a power storage device such as the one described in Japanese Patent Laying-Open No. H10-69893 is mounted on a vehicle, it is required to reduce vibrations of the power storage device to the vehicle. Additionally, there is concern that the upper cover will come into contact with a power storage stack when a downward load is input to the power storage device from the upper side.

An object of the present disclosure is to provide a power storage device that enables it to inhibit both vibrations of the power storage device to a vehicle and contact of an upper cover with a power storage stack.

A power storage device according to an aspect of the present disclosure includes a power storage stack including a plurality of power storage cells, a lower case accommodating the power storage stack, an upper cover covering the power storage stack, an outside elastic body made of an elastic material and provided on an outer surface of the upper cover, and an inside elastic body made of an elastic material and provided on an inner surface of the upper cover, and the inside elastic body has a spring constant larger than a spring constant of the outside elastic body.

The foregoing and other objects, features, aspects, and advantages of the present disclosure will become apparent from the following detailed description of the present disclosure, which will be understood in conjunction with the accompanying drawings.

### BRIEF DESCRIPTION OF THE DRAWINGS

FIG. 1 is a perspective view that schematically illustrates a power storage device according to an embodiment of the present disclosure.

FIG. 2 is a perspective view that schematically illustrates a state in which an upper cover is removed from the power storage device in FIG. 1.

FIG. 3 is a cross-sectional view along line III-III in FIG. 1.

FIG. 4 is a perspective view that schematically illustrates an outside elastic body and an inside elastic body.

FIG. 5 schematically illustrates a CAE analysis result of distribution of stress caused in the outside elastic body when a uniform load acts on an upper surface of the outside elastic body.

FIG. 6 is a plan view that schematically illustrates a variation of the outside elastic body.

FIG. 7 is a plan view that schematically illustrates a variation of the outside elastic body.

FIG. 8 is a plan view that schematically illustrates a variation of the outside elastic body.

FIG. 9 is a plan view that schematically illustrates a variation of the outside elastic body.

FIG. 10 is a perspective view that schematically illustrates a variation of the outside elastic body.

### DESCRIPTION OF THE PREFERRED EMBODIMENTS

Embodiments of the present disclosure are described with reference to the drawings. In the drawings referred to below, the same reference numerals are given to identical or equivalent members.

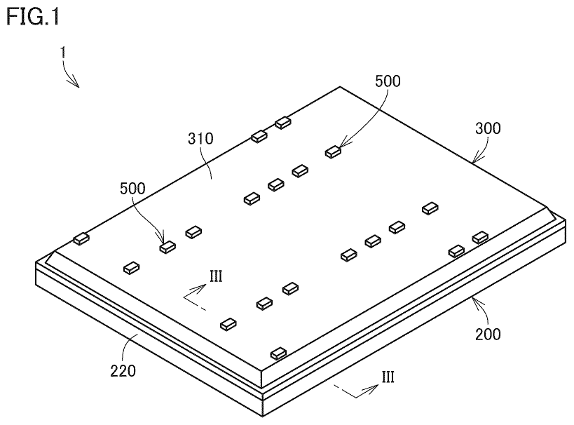

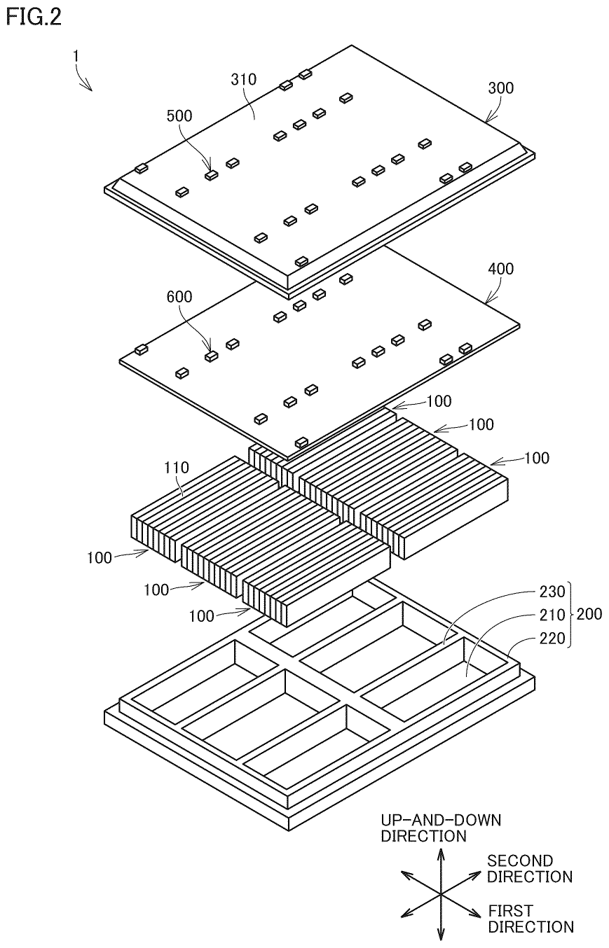

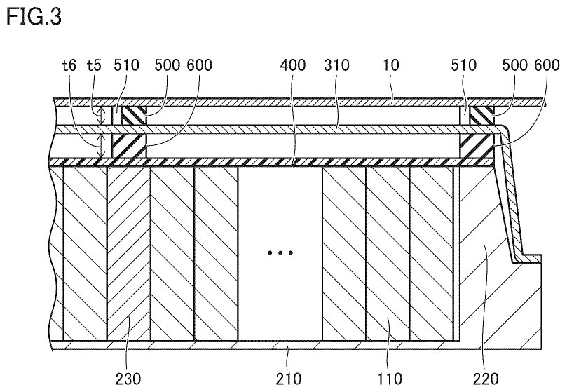

FIG. 1 is a perspective view that schematically illustrates a power storage device 1 according to an embodiment of the present disclosure. FIG. 2 is an exploded perspective view of power storage device 1 illustrated in FIG. 1. FIG. 3 is a cross-sectional view along line III-III in FIG. 1. Power storage device 1 is mounted on a bottom portion 10 of a vehicle (see FIG. 3) for example.

As illustrated in FIGS. 1 to 3, power storage device 1 includes at least one power storage stack 100, a lower case 200, an upper cover 300, a plate material 400, at least one outside elastic body 500, and at least one inside elastic body 600.

The at least one power storage stack 100 includes a plurality of power storage stacks 100. In the present embodiment, power storage device 1 includes six power storage stacks 100. However, the number of power storage stacks 100 is not limited to six.

Each power storage stack 100 includes a plurality of power storage cells 110, which are arranged side by side in a first direction. Examples of each power storage cell 110 include a lithium ion battery. Each power storage cell 110 may be constituted of an all-solid-state battery that employs a solid electrolyte. As illustrated in FIG. 2, each power storage cell 110 is formed to have a shape of a flat rectangular parallelepiped. The length of power storage cell 110 in a second direction orthogonal to both the first direction and an up-and-down direction is larger than the length of power storage cell 110 in the up-and-down direction. The plurality of power storage stacks 100 are arranged side by side so as to be spaced in the first direction while being arranged side by side so as to be spaced in the second direction.

Lower case 200 accommodates the plurality of power storage stacks 100. Lower case 200 is opened upward. Lower case 200 includes a bottom wall 210, a peripheral wall 220, and a load transmission portion 230.

Bottom wall 210 supports each power storage stack 100. Bottom wall 210 may include a cooling plate that is in contact with a bottom portion of each power storage stack 100.

Peripheral wall 220 is erected from an edge portion of bottom wall 210. Peripheral wall 220 surrounds the plurality of power storage stacks 100.

Load transmission portion 230 transmits, to bottom wall 210, a load input downward to upper cover 300. Load transmission portion 230 is erected from bottom wall 210. As illustrated in FIG. 2, load transmission portion 230 is arranged between a pair of power storage stacks 100 adjacent to each other in the first direction. Load transmission portion 230 serves as a partition between a pair of power storage stacks 100 adjacent to each other in the first direction. Load transmission portion 230 is contiguous to peripheral wall 220. That is, load transmission portion 230 has a function of reinforcing peripheral wall 220. As illustrated in FIG. 3, the height of load transmission portion 230 from bottom wall 210 is set so as to be substantially the same as the height of peripheral wall 220 from bottom wall 210.

Upper cover 300 covers the plurality of power storage stacks 100. Upper cover 300 is opened downward. Upper cover 300 accommodates the plurality of power storage stacks 100 together with lower case 200. An edge portion of upper cover 300 is fixed to lower case 200 using bolts or the like. Upper cover 300 includes a top wall 310 arranged over the plurality of power storage stacks 100. Top wall 310 may be formed to have a flat plate shape.

Plate material 400 presses the plurality of power storage stacks 100 against bottom wall 210. Plate material 400 may be formed to have a flat plate shape. Plate material 400 is made of synthetic resin or the like. Plate material 400 is arranged so as to extend over the plurality of power storage stacks 100 and load transmission portion 230. As illustrated in FIG. 3, an edge portion of plate material 400 is in contact with an upper surface of peripheral wall 220.

The at least one outside elastic body 500 includes a plurality of outside elastic bodies 500. Each outside elastic body 500 is provided on an outer surface of upper cover 300. Each outside elastic body 500 is made of an elastic material such as urethane. Each outside elastic body 500 is formed to have a shape of a flat rectangular parallelepiped. The plurality of outside elastic bodies 500 are arranged so as to be spaced from each other. As illustrated in FIGS. 2 and 3, each outside elastic body 500 is arranged in a position where each outside elastic body 500 overlaps load transmission portion 230 in the up-and-down direction, that is, over load transmission portion 230.

The at least one inside elastic body 600 includes a plurality of inside elastic bodies 600. Each inside elastic body 600 is provided on an inner surface of upper cover 300. Each inside elastic body 600 is made of an elastic material such as urethane. Each inside elastic body 600 is formed to have a shape of a flat rectangular parallelepiped. Each inside elastic body 600 may be formed to have the same shape as the shape of outside elastic body 500. The plurality of inside elastic bodies 600 are arranged so as to be spaced from each other. As illustrated in FIGS. 2 and 3, each inside elastic body 600 is arranged in a position where each inside elastic body 600 overlaps outside elastic body 500 in the up-and-down direction. Each inside elastic body 600 is arranged over load transmission portion 230. In the present embodiment, each inside elastic body 600 is sandwiched between top wall 310 of upper cover 300 and plate material 400.

The spring constant [N/mm] of each inside elastic body 600 is larger than the spring constant [N/mm] of each outside elastic body 500. The “spring constant” includes a static spring constant and a dynamic spring constant. How to measure the static spring constant and the dynamic spring constant is based on JIS K 6385. That is, the spring constant is calculated on the basis of a relation between a load that acts on each elastic body 500, 600 and flexion of each elastic body 500, 600 at the time.

The hardness (type C) of each inside elastic body 600 is larger than the hardness (type C) of each outside elastic body 500. How to measure the hardness (type C) is based on JIS K 7312. That is, the hardness is calculated on the basis of reaction force that, when a test piece of each elastic body 500, 600 is pushed with a push needle, acts on the push needle from the test piece.

As illustrated in FIG. 3, a thickness t6 of each inside elastic body 600 is larger than a thickness t5 of each outside elastic body 500. Thickness t6 of each inside elastic body 600 may be smaller than or equal to thickness t5 of each outside elastic body 500.

One elastic body of outside elastic body 500 and inside elastic body 600 includes a distinctive element making the one elastic body distinguishable from the other elastic body of outside elastic body 500 and inside elastic body 600. In the present embodiment, outside elastic body 500 includes a distinctive element 510 (see FIGS. 3 and 4). Inside elastic body 600 may include a distinctive element. Distinctive element 510 is not illustrated in FIGS. 1 and 2.

As illustrated in FIGS. 3 and 4, distinctive element 510 is constituted of a cut portion. In a plan view, outside elastic body 500 includes a long-side portion 501 and a short-side portion 502, and the cut portion is formed in a central portion of long-side portion 501. The cut portion has a shape that is depressed inward in a direction parallel to short-side portion 502. As illustrated in FIG. 4, inside elastic body 600 also includes a long-side portion 601 and a short-side portion 602. The position where the cut portion is provided is described with reference to FIG. 5.

FIG. 5 schematically illustrates a CAE analysis result of distribution of stress caused in outside elastic body 500 when a uniform load is applied to an upper surface of outside elastic body 500. FIG. 5 shows that the largest stress is caused in region A and the stress decreases in the order of regions A, B, C, D, and E. As illustrated in FIG. 5, the stress caused in the central portion of long-side portion 501 is relatively small. It is thus demonstrated that even when a cut portion is formed in the central portion of long-side portion 501, a cushioning function of outside elastic body 500 is substantially maintained. Accordingly, in the present embodiment, a cut portion as distinctive element 510 is formed in the central portion of long-side portion 501 as illustrated in FIG. 4.

As described above, since outside elastic body 500 is provided on the outer surface of upper cover 300 in power storage device 1 of the present embodiment, vibrations of power storage device 1 to a vehicle in a case where power storage device 1 is mounted on bottom portion 10 of the vehicle are effectively inhibited. Further, since inside elastic body 600 having a relatively large spring constant is provided on the inner surface of upper cover 300, collision of top wall 310 with power storage stack 100 is inhibited in a case where downward external force acts on top wall 310 of upper cover 300.

Outside elastic body 500 includes distinctive element 510, which facilitates distinction between outside elastic body 500 and inside elastic body 600. Thus, false arrangement of outside elastic body 500 and inside elastic body 600 in assembling power storage device 1 is inhibited.

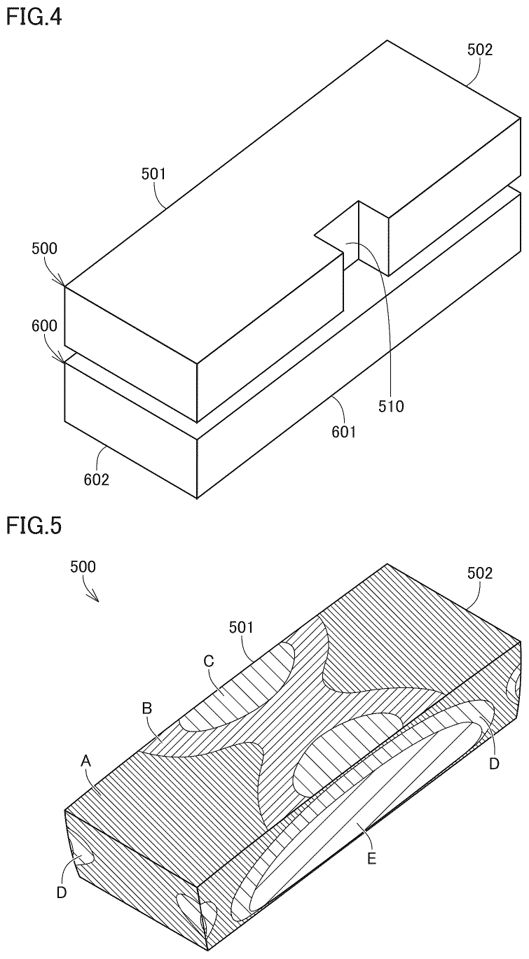

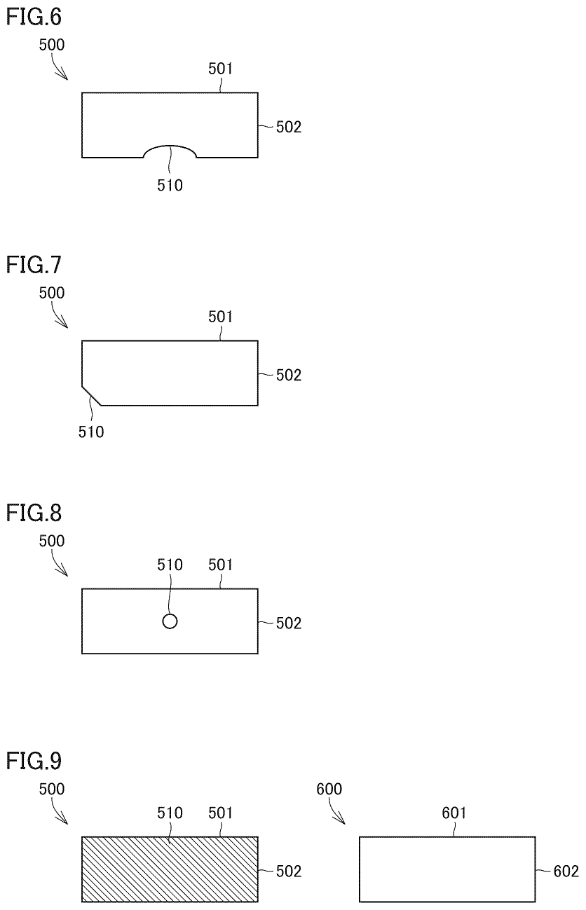

The form of distinctive element 510 is not limited to the example of the foregoing embodiment but can be changed variously. Variations of distinctive element 510 are described below with reference to FIGS. 6 to 10.

As illustrated in FIG. 6, distinctive element 510 may be formed to have a shape that is inwardly rounded to be concave.

As illustrated in FIG. 7, distinctive element 510 may be formed in a corner portion of outside elastic body 500.

As illustrated in FIG. 8, distinctive element 510 may be constituted of an indication portion connected to a surface of outside elastic body 500. For another example, distinctive element 510 may be constituted of a through hole formed in a central portion of outside elastic body 500.

As illustrated in FIG. 9, distinctive element 510 may have a color different from the color of inside elastic body 600. In FIG. 9, oblique lines denote that the color of the surface of outside elastic body 500 is different from the color of the surface of inside elastic body 600.

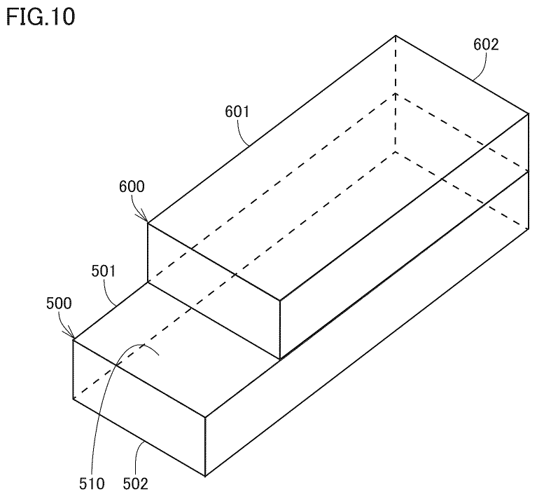

As illustrated in FIG. 10, outside elastic body 500 may include a projecting portion projecting from inside elastic body 600 in a plan view when outside elastic body 500 and inside elastic body 600 are laid on each other, and distinctive element 510 may be constituted of the projecting portion.

Those skilled in the art will understand that the above-described exemplary embodiments are specific examples of the following aspects.

### Aspect 1

A power storage device comprising:
a power storage stack including a plurality of power storage cells;
a lower case accommodating the power storage stack;
an upper cover covering the power storage stack;
an outside elastic body made of an elastic material and provided on an outer surface of the upper cover; and
an inside elastic body made of an elastic material and provided on an inner surface of the upper cover,
the inside elastic body having a spring constant larger than a spring constant of the outside elastic body.

In the power storage device, the outside elastic body having a relatively small spring constant is provided on the outer surface of the upper cover. Thus, vibrations of the power storage device to a vehicle in a case where the power storage device is mounted on the vehicle are effectively inhibited. Further, the inside elastic body having a relatively large spring constant is provided on the inner surface of the upper cover. Accordingly, collision of the upper cover with the power storage stack in a case where downward external force acts on the upper cover is inhibited.

### Aspect 2

The power storage device according to aspect 1, wherein one elastic body of the outside elastic body and the inside elastic body includes a distinctive element making the one elastic body distinguishable from the other elastic body of the outside elastic body and the inside elastic body.

According to this aspect, since one elastic body is distinguishable from the other elastic body, false arrangement of the outside elastic body and the inside elastic body in assembling the power storage device is inhibited.

### Aspect 3

The power storage device according to aspect 2, wherein
in a plan view, each of the outside elastic body and the inside elastic body is formed to have a shape of a rectangular parallelepiped including a long-side portion and a short-side portion, and
the distinctive element is constituted of a cut portion formed in a central portion of the long-side portion of the one elastic body.

According to this aspect, distinction is enabled while cushioning performance is substantially maintained.

### Aspect 4

The power storage device according to aspect 2, wherein the distinctive element has a color different from a color of the other elastic body.

### Aspect 5

The power storage device according to aspect 2, wherein
in a plan view, each of the outside elastic body and the inside elastic body is formed to have a shape of a rectangular parallelepiped including a long-side portion and a short-side portion,
the one elastic body includes a projecting portion projecting from the other elastic body in a plan view when the outside elastic body and the inside elastic body are laid on each other, and
the distinctive element is constituted of the projecting portion.

### Aspect 6

The power storage device according to aspect 1, wherein the inside elastic body is arranged in a position where the inside elastic body overlaps the outside elastic body in an up-and-down direction.

### Aspect 7

The power storage device according to aspect 6, wherein
the lower case includes
   a bottom wall, and
   a load transmission portion that transmits, to the bottom wall, load input downward to the upper cover,
the load transmission portion is erected from the bottom wall and arranged on a side of the power storage stack, and
the inside elastic body is arranged over the load transmission portion.

According to this aspect, since a load input downward to the upper cover is received at the bottom wall via the inside elastic body and the load transmission portion, damage to the power storage stack caused by the load is inhibited.

### Aspect 8

The power storage device according to aspect 7, further comprising
a plate material that presses the power storage stack against the bottom wall, wherein
the plate material is arranged so as to extend over the power storage stack and the load transmission portion, and
the inside elastic body is sandwiched between the upper cover and the plate material.

According to this aspect, a load input downward to the upper cover is transmitted to the bottom wall more effectively.

Although embodiments of the present disclosure have been described, it should be understood that the herein-disclosed embodiments are presented by way of illustration and example in every respect and are not to be taken by way of limitation. The scope of the present disclosure is defined by the claims and intended to include all changes within the purport and scope equivalent to the claims.

What is claimed is:

1. A power storage device comprising:
a power storage stack including a plurality of power storage cells;
a lower case accommodating the power storage stack;
an upper cover covering the power storage stack;
an outside elastic body made of an elastic material and provided on an outer surface of the upper cover; and
an inside elastic body made of an elastic material and provided on an inner surface of the upper cover,
the inside elastic body having a spring constant larger than a spring constant of the outside elastic body.

2. The power storage device according to claim 1, wherein one elastic body of the outside elastic body and the inside elastic body includes a distinctive element making the one elastic body distinguishable from the other elastic body of the outside elastic body and the inside elastic body.

3. The power storage device according to claim 2, wherein
in a plan view, each of the outside elastic body and the inside elastic body is formed to have a shape of a rectangular parallelepiped including a long-side portion and a short-side portion, and
the distinctive element is constituted of a cut portion formed in a central portion of the long-side portion of the one elastic body.

4. The power storage device according to claim 2, wherein the distinctive element has a color different from a color of the other elastic body.

5. The power storage device according to claim 2, wherein
in a plan view, each of the outside elastic body and the inside elastic body is formed to have a shape of a rectangular parallelepiped including a long-side portion and a short-side portion,
the one elastic body includes a projecting portion projecting from the other elastic body in a plan view when the outside elastic body and the inside elastic body are laid on each other, and
the distinctive element is constituted of the projecting portion.

6. The power storage device according to claim 1, wherein the inside elastic body is arranged in a position where the inside elastic body overlaps the outside elastic body in an up-and-down direction.

7. The power storage device according to claim 6, wherein
the lower case includes
a bottom wall, and
a load transmission portion that transmits, to the bottom wall, load input downward to the upper cover,
the load transmission portion is erected from the bottom wall and arranged on a side of the power storage stack, and
the inside elastic body is arranged over the load transmission portion.

8. The power storage device according to claim 7, further comprising
a plate material that presses the power storage stack against the bottom wall, wherein
the plate material is arranged so as to extend over the power storage stack and the load transmission portion, and
the inside elastic body is sandwiched between the upper cover and the plate material.
